(19) United States
(12) Patent Application Publication
(10) Pub. No.: US 2020/0040934 A1
(43) Pub. Date: Feb. 6, 2020

(54) ANTI-ROTATION PIN AND SWAGED RING LOCK FOR A THREADED JOINT ON A STRUT

(71) Applicant: Rolls-Royce Corporation, Indianapolis, IN (US)

(72) Inventor: Michael S. Bell, Indianapolis, IN (US)

(21) Appl. No.: 16/053,487

(22) Filed: Aug. 2, 2018

(51) Int. Cl. F16B 39/04; B64D 27/26; B21D 39/04; B23P 11/00

(52) U.S. Cl. CPC F16B 39/04; B64D 27/26; B64D 2027/262; B23P 11/00; B21D 39/04

(57) ABSTRACT

A strut and method for assembling a strut. The strut comprises two strut members attachable by a threading mechanism or the like. A first strut member is screwed into the second strut member. A pin hole is formed at the seam between the strut members and a pin is inserted into the pin hole. A locking ring is formed around the pin hole that includes an angular lip adjacent to the hole. The locking of the pin is accomplished, by swaging the angular lip into the hole and over the pin to lock the pin in the pin hole. The purpose of the pin is to ensure the joint does not untwist during operation.

### FIELD OF DISCLOSURE

The present invention relates to systems and methods for assembling a strut at a threaded joint, and more particularly, for locking the threaded joint to prevent rotation and disassembly of the strut.

### BACKGROUND

Large manufactured structures often use struts, or a large rod, bar or member to support large loads, typically to resist compression, tension, or torsion. One example of such a strut is used in the mounting apparatus of an engine on an aircraft. Aircraft are typically powered by gas turbine engines mounted to either the aircraft's fuselage, the tail, or the wings. The engine may be mounted using a variety of structures. Typically, particularly where the engine is mounted on a wing, the engine is mounted to a pylon attached to the wing via a thrust strut between the pylon and the engine.

The total weight of an aircraft is an important consideration in the design of an aircraft due to the role weight plays in fuel efficiency as well as other factors. Engineers typically consider the weight of each component added to the aircraft structure in designing the aircraft. The components used in mounting the engines are designed to be capable of withstanding the force of the thrust generated by the gas turbine engines and to remain firmly attached to the aircraft structure. The materials typically deemed best to provide the strength to reliably maintain the engines attached to the aircraft structure include metals, such as steel, aluminum, and other metals. The use of such materials results in a design tradeoff between the strength provided by metals and the increase in weight associated with these materials.

With respect to the thrust struts, the amount of metal used to sufficiently strengthen the thrust strut can be significant. One way to reduce the weight without unduly compromising the strength of the thrust strut is to manufacture the thrust struts as hollow members. Hollow thrust struts are typically manufactured as separate members that are hollowed out and then attached. The hollow members may be molded or bored and assembled using an attachment mechanism. One such attachment mechanism is a threaded joint having a threaded end on one member that screws into a corresponding threading in the cavity of the other member.

One problem with using threading is that it may loosen or unscrew during operation of the aircraft due to the forces exerted on the hollow thrust strut. The attached thrust strut members may be locked by inserting a pin into a hole located at the seam formed where the members attach. Typically, the pin is dimensioned so that when inserted, a pin surface sits below the surface of the members at the seam. The edges of the hole surrounding the pin are then knocked into the hole over the pin using a punch to lock the pin in place.

The pin prevents the strut members from rotating and possibly becoming unattached. The pin is locked in by the punched edges over the pin. However, the process of knocking the edges of the hole over the pin is dependent on the human use of the punch. The results are typically variable and may include instances when the pin slips out of the hole during the flight of the aircraft.

The thrust strut on an aircraft is only one example of a threaded strut that bears a substantial load and may be subject to forces that may act to unlock a threaded joint. Other struts having either a threaded attachment mechanism or another type of attachment mechanism may also require a locking pin to prevent rotational forces from causing an unintentional disassembly of the strut.

### SUMMARY

In view of the above, a strut is configured to support a load. The strut comprises a first strut member having a first attachment mechanism at a first abutment face. A second strut member having a second abutment face and a second attachment mechanism configured to receive the first attachment mechanism of the first strut member until the second abutment face is substantially in contact with the first abutment face. A pin is provided with an angled chamfer around at least one surface. A pin hole is formed in the strut to receive the pin. The pin hole is formed at a seam where the first abutment face and the second abutment face are substantially in contact. A locking ring surrounds the pin hole and formed as a channel in a surface of the strut. The channel may be formed with an angular lip extending from the surface. The angular lip is machined to lock the pin into the pin hole by a machining process.

In another aspect, a method is provided for assembling a strut. The method comprises inserting a threaded portion extending from a first abutment face of a first strut member into a thread formed inward from a second abutment face on a second strut member until the first abutment face is in substantial contact with the second abutment face. A pin hole is formed in a seam faulted where the first abutment face contacts the second abutment face. A locking ring is formed around the pin hole as a channel in a surface of the strut and an angular lip extending from the surface of the strut. A pin having a chamfered edge is inserted into the pin hole. The angular lip is machined to extend into the pin hole until the angular lip locks the pin in the pin hole.

Some examples of devices, systems, and methods for preventing rotation of a strut member at a threaded joint are outlined above rather broadly in order that the detailed description thereof may be better understood, and in order that the present contribution to the art may be better appreciated. Additional example implementations of the devices, systems, and methods are described below and will form the subject matter of the claims appended hereto. In this respect, before explaining at least one example of the devices, systems, and methods in detail, it is to be understood that the devices, systems, and methods are not limited in their application to the details of construction or to the arrangements of the components set forth in the following description or illustrated in the drawings. Other example implementations of the devices, systems, and methods may be developed, practiced and carried out in various ways. Also, it is to be understood that the phraseology and terminology employed herein are for the purpose of the description and should not be regarded as limiting.

### BRIEF DESCRIPTION OF THE DRAWINGS

FIG. 1 is a cross-sectional view of a gas turbine engine.

FIG. 2 is a side-view of a part of the gas turbine engine with an attached thrust strut.

FIG. 3 is an isometric view of an example of a strut.

FIG. 4 is an isometric view of an end of a strut depicting where a first strut member attaches to a second strut member.

FIG. 5 is an isometric cross-sectional view of Detail A in FIG. 4.

FIG. 6 is an isometric view of Detail B in FIG. 5.

FIG. 7A is a side cross-sectional view of a pin mounted in a hole across a seam formed by a joinder of a first strut member and a second strut member attached by a buttress thread.

FIG. 7B is a side cross-sectional view of Detail C in FIG. 7A showing the pin locked in the hole by swaging.

FIG. 8 is a top view of the surface of the strut showing the pin locked in the hole by swaging.

### DETAILED DESCRIPTION

As used herein, the term “strut” shall mean any rod, bar or other member used to support a load by resisting compression, tension, and/or torsion. It is noted that example implementations of anti-rotations pins and locking rings for locking threaded joints are described below in the context of a strut for attaching an engine to an aircraft. Those of ordinary skill in the art will understand that example implementations of anti-rotations pins and locking rings described herein may also be used in other applications or structures without limitation.

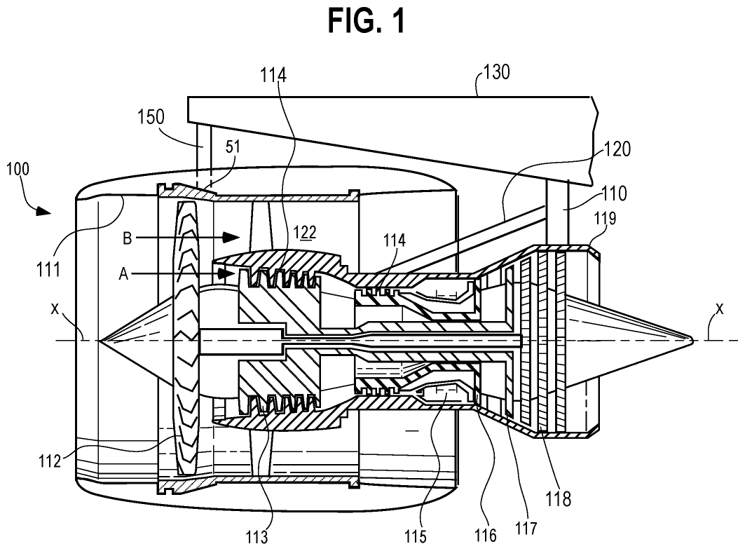

With reference to FIG. 1, a fan gas turbine engine 100 comprises, in axial flow series, an air intake 111, a propulsive fan 112, an intermediate pressure compressor 113, a high-pressure compressor 114, combustion equipment 115, a high-pressure turbine 116, and intermediate pressure turbine 117, a low-pressure turbine 118 and a core engine exhaust nozzle 119. The engine 100 also has a bypass duct 122 and a bypass exhaust nozzle 123.

The gas turbine engine 100 works in a conventional manner so that air entering the air intake 111 is accelerated by the fan 112 to produce two air flows: a first air flow A into the intermediate pressure compressor 113 and a second air flow B which passes through the bypass duct 122 to provide propulsive thrust. The intermediate pressure compressor 113 compresses the air flow A directed into it before delivering that air to the high pressure compressor 114 where further compression takes place.

The compressed air exhausted from the high-pressure compressor 114 is directed into the combustion equipment 115 where it is mixed with fuel and the mixture combusted. The resultant hot combustion products then expand through, and thereby drive the high, intermediate and low-pressure turbines 116, 117, 118 before being exhausted through the nozzle 119 to provide additional propulsive thrust. The high, intermediate and low-pressure turbines 116, 117, 118 respectively drive the high and intermediate pressure compressors 114, 113 and the fan 112 by suitable interconnecting shafts extending through a rotational axis X-X.

Each of the high, intermediate and low-pressure turbines 116, 117, 118 and the intermediate and high-pressure compressors 113, 114 comprises at least one stage comprising a set of rotor blades and a set of stator vanes. In use, the rotor blades rotate around the engine axis X-X, while the stator vanes are stationary within the engine.

It will be appreciated that the gas turbine engine 100 if FIG. 1 is shown by way of example only, and the present disclosure may be applied to any other type of gas turbine engine, for example with any arrangement of turbines, compressors, shafts and casings.

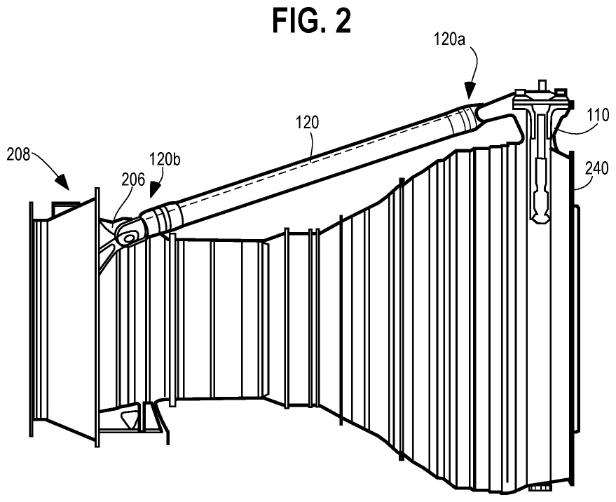

FIG. 1 also shows a pylon 130 to which the gas turbine engine 100 is mounted via a front mounting arrangement 150, and a rear mounting arrangement 110 to form a gas turbine engine installation. The gas turbine engine installation also comprises a strut 120, through which the motive force generated by the engine is transmitted to the pylon 130. The strut 120 may be referred to as a thrust strut as implemented in the examples shown in FIGS. 1 and 2. The terms “strut” and “thrust strut” shall be used interchangeably below unless stated otherwise. The pylon 130 may be a part of an aircraft (for example attached to the wing of an aircraft), and thus the gas turbine engine installation may be part of an aircraft. Further details of the gas turbine engine installation are discussed below in relation to FIGS. 2 to 7B.

FIG. 2 is a side view of a part of the engine 100 shown in FIG. 1. In this example arrangement, an aft end 120a of the strut 120 is connected to the rear mounting 110, which is also connected to a rear core casing 240 and a pylon 130 (in FIG. 1). A fore end 120b of the strut 120 attaches to a fore strut mounting 206, which is also connected to a fore core casing 208. The forward part of the engine 100 is attached to the pylon 130 at the front mounting 150, which attaches to the engine 100 at a fan casing 51 as shown in FIG. 1. Alternative mounting arrangements may be used to mount the engine 100. The strut 120 may also be attached in different manners to provide a thrust absorbing function between the engine 100 and the aircraft mounting structure, such as for example, the pylon 130 (in FIG. 1).

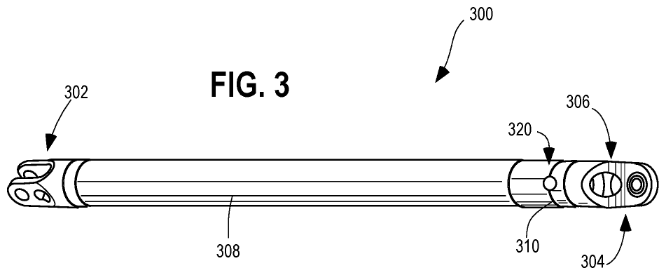

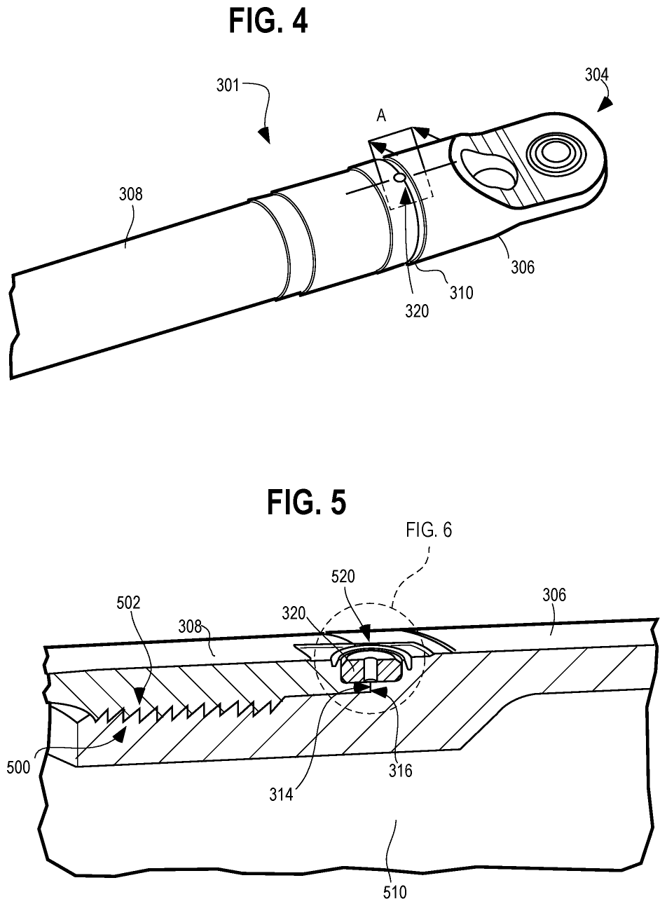

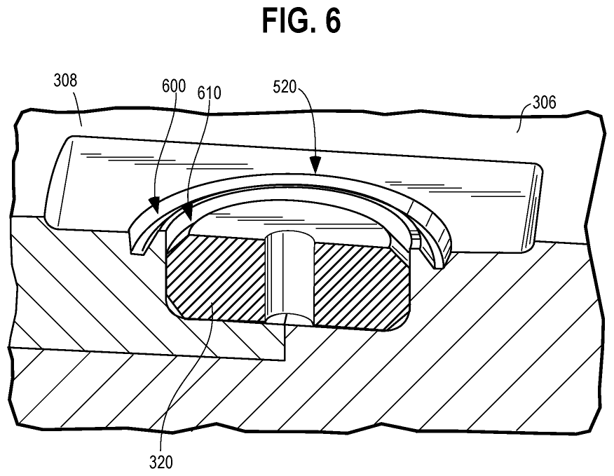

FIG. 3 is an isometric view of an example of a strut 300 that may be used as described above with reference to FIGS. 1 and 2. FIG. 4 is an isometric view of an end 301 of the strut 300 depicting where the first strut member 306 attaches to the second strut member 308. FIG. 5 is an isometric cross-sectional view of Detail A in FIG. 4. FIG. 6 is an isometric view of Detail B in FIG. 5.

Referring to FIGS. 3-6, the strut includes a first attachment portion 302, a second attachment portion 304, a first strut member 306, and a second strut member 308 attached to the first strut member 304. The first strut member 306 has a first abutment face 314 (shown in FIG. 5) and the second strut member 308 has a second abutment face 316 (shown in FIG. 5). The first strut member 306 and the second strut member 308 are attached, typically by attaching a first attachment mechanism, which is a threaded portion 500 (shown in FIG. 5) in the examples shown in the figures, extending from the first abutment face 314 into a second attachment mechanism, which is a thread 502 (shown in FIG. 5) formed inward the second strut member 308. In the examples illustrated in FIGS. 1-7B, the first strut member 306 is screwed into the second strut member 316 until the first abutment face 314 is in substantial contact with the second abutment face 316 forming a seam 310 (shown in FIG. 3). In an example implementation, the thread 502 in the second strut member 308 is a buttress thread, but other types of threading may be used. In other implementations, other types of attachment, such as for example, a bayonet, a press fit, a heat shrink fit, or any other attachment mechanism in which it is desired to limit rotation of the members, may be used. A pin 320 is inserted at the seam 310 to lock the attachment of the first strut member 306 and the second strut member 308.

The first strut member 306 and the second strut member 308 are hollow. As shown in FIG. 5, which is Detail A in FIG. 4, the first strut member 306 and the second strut member 308 form a hollow space 510 when attached. The pin 320 is inserted into a pin hole 520, which is formed as a recess in the surface of the strut member 300 at the seam 310 where the first strut member 306 and the second strut member 308 are in contact. The pin hole 520 may include an extension hole having a smaller diameter extending into the opposite surface of the hollow space 510 of the strut 300 in alternative implementations. The pin 320 may also include an extension pin suitable for mating with the extension hole.

The pin hole 520 may be sized to receive the pin 320. A locking ring 600 may be formed around the pin hole 520 as shown in FIG. 6, which is Detail B from FIG. 5. The locking ring 600 may be formed as a channel in the surface of the strut that surrounds the pin hole 520. The locking ring 600 may include an angular lip 650 extending from a side surface of the pin hole 520 and angling into the locking ring 600. The pin 320 is also formed to include an angled chamfer 610 surrounding an upper surface of the pin 320. The angled chamfer 610 may be a surface at any suitable angle. In one example implementation, the angle of the angled chamfer 610 is about 45°. The selected angle of the angled chamfer 610 may or may not be the same as the selected angle of the angular lip on the locking ring 600. The angular lip 650 may be machined, by a machining process such as swaging for example, to extend into the pin hole 520 until contact is made with the angled chamfer 610 of the pin 320. The pin 320 may be made if any suitable metal having sufficient strength to lock the strut members 306, 308 to keep them from coming apart.

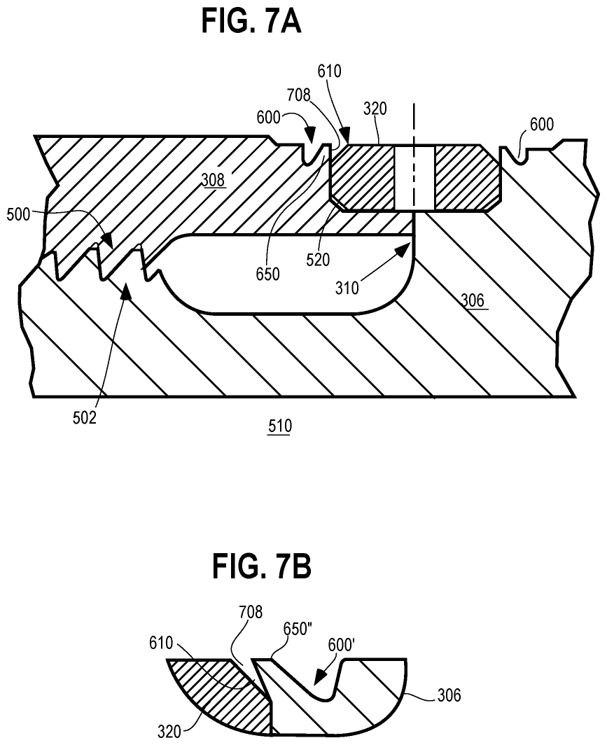

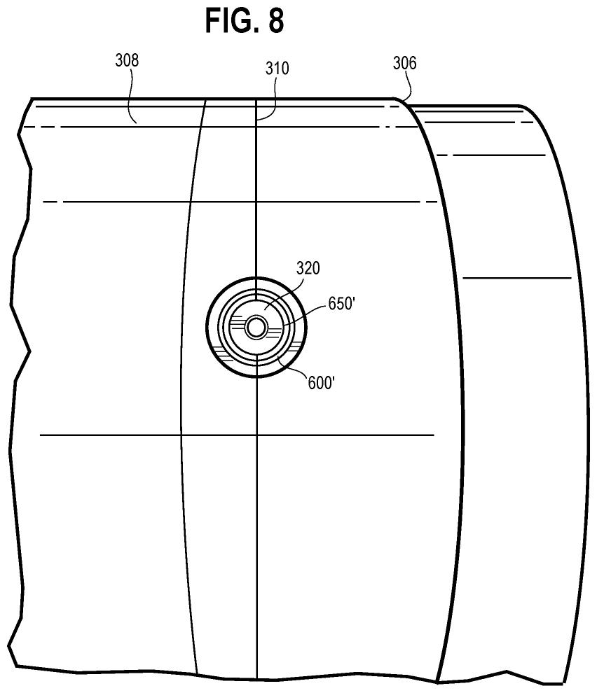

FIG. 7A is a side cross-sectional view of the pin 320 mounted in the pin hole 520 across the seam 310 formed by the joinder of the first strut member 306 and the second strut member 308 attached by the buttress thread 502 and threaded portion 500. The pin 320 is shown in FIG. 7A in an unlocked state leaving a space 708 between the angular lip 650 on the locking ring 600 and the angled chamfer 610 on the pin 320.

FIG. 7B is a side cross-sectional view of Detail C in FIG. 7A showing the pin 320 locked in the pin hole 520. The angular lip 650 (in FIG. 7A) on the locking ring 600 may be machined, for example, by swaging, to contact the angled chamfer 610. The machined angular lip 650′ in FIG. 7B extends over the angled chamfer 610 preferably contacting the angled chamfer 610. The machining of the angular lip 650′ may widen the channel formed by the locking ring as shown at 600′ in FIG. 7B. A minimum gap may be specified at 708′by determining a minimum tolerance for a gap between the angled chamfer 610 of the pin 320 and the machined angular lip 650′ that would keep the pin 320 locked in the pin hole 520.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure. Numerous modifications to the present disclosure will be apparent to those skilled in the art in view of the foregoing description. It should be understood that the illustrated embodiments are exemplary only, and should not be taken as limiting the scope of the disclosure.

What is claimed is:

1. A strut configured to support a load, the strut comprising:
a first strut member having a first attachment mechanism at a first abutment face;
a second strut member having a second abutment face and a second attachment mechanism to receive the first attachment mechanism of the first strut member until the second abutment face is substantially in contact with the first abutment face;
a pin having an angled chamfer around at least one surface;
a pin hole configured to receive the pin, where the pin hole is formed in the strut at a seam formed where the first abutment face and the second abutment face are substantially in contact;
a locking ring surrounding the pin hole, the locking ring formed as a channel in a surface of the strut, the channel having an angular lip extending from the surface, where the angular lip is machined to lock the pin into the pin hole by a forging process.

2. The strut of claim 1 where the first attachment mechanism is a threaded portion extending outward from the first abutment face, and the second attachment mechanism is a thread formed inward the second strut member to receive the threaded portion of the first strut member until the second abutment face is substantially in contact with the first abutment face.

3. The strut of claim 1 where the pin hole is formed as a recess in the surface of the strut having a depth and a recess surface at the depth of the recess.

4. The strut of claim 1 where the pin hole is formed as a first recess in the surface of the strut having a depth and a recess surface at the depth of the recess, and a second recess extending inward from the recess surface.

5. The strut of claim 1 where the machining process is a swaging process.

6. The strut of claim 1 where the angular lip includes an angular lip surface formed at an angle that is substantially the same as the angled chamfer on the pin.

7. The strut of claim 1 where the pin chamfer is about 45° or about 60°.

8. The strut of claim 6 where the angle of the angular lip surface is about 45° or about 60°.

9. The strut of claim 2 where the thread is a buttress thread.

10. The strut of claim 1 where the first strut member or the second strut member are substantially hollow.

11. A method of assembling a strut comprising:
inserting a threaded portion extending from a first abutment face of a first strut member into a thread formed inward from a second abutment face on a second strut member until the first abutment face is in substantial contact with the second abutment face;
forming a pin hole in a seam formed where the first abutment face contacts the second abutment face;
forming a locking ring around the pin hole, where the locking ring is formed as a channel in a surface of the strut and an angular lip extending from the surface of the strut;
inserting a pin having a chamfered edge into the pin hole; and
machining the angular lip to extend into the pin hole until the angular lip locks the pin in the pin hole.

12. The method of claim 11 where the machining step includes swaging the angular lip over the pin chamfer.

13. The method of claim 11 where the step of forming the locking ring includes machining the locking ring using a form tool.

14. The method of claim 11 where the step of forming the pin hole comprises drilling a recess into the surface of the strut at the seam.

15. The method of claim 11 where the chamfered edge on the pin is formed to a first predetermined angle, and the step of forming the locking ring includes forming the angular lip at a second predetermined angle.

16. The method of claim 15 where the first predetermined angle is the same as the second predetermined angle.

17. The method of claim 11 further comprising forming a chamfer on a cylindrical pin at about a 45° or about a 60° surface angle to prepare the pin for insertion into the pin hole.

18. The method of claim 15 the step of forming the locking ring includes forming the angular lip to have about a 45° or about a 60° surface.

19. The method of claim 11 where the step of inserting the threaded portion of the first strut member into the thread of the second strut member comprises threading the threaded portion of the first strut member into the thread of the second strut member where the first strut member and the second strut member are substantially hollow.
